(19) United States
(12) Patent Application Publication
(10) Pub. No.: US 2024/0381905 A1
(43) Pub. Date: Nov. 21, 2024

(54) TUNNEL PASTEURIZER AND METHOD FOR MONITORING AND CONTROLLING A TUNNEL PASTEURIZER

(71) Applicant: Krones AG, Neutraubling (DE)

(72) Inventors: Andreas MEYER, Parkstetten (DE); Markus STUBENHOFER, Regensburg (DE)

(21) Appl. No.: 18/662,565

(22) Filed: May 13, 2024

(30) Foreign Application Priority Data
May 19, 2023 (DE) 102023113161.3

(51) Int. Cl. A23L 3/00; A23L 2/44; A23L 2/46

(52) U.S. Cl. CPC A23L 3/003; A23L 2/44; A23L 2/46

(57) ABSTRACT

A tunnel pasteurizer for pasteurization of filling products and a method for the monitoring and control thereof are described. The tunnel pasteurizer comprises sensors for locally monitoring at least one consumable parameter and at least one machine parameter relating to the transport and/or the temperature control of the filling products, a data output for transmitting measurement data obtained by such sensor monitoring from the tunnel pasteurizer, and at least one data input for receiving external control data for controlling the tunnel pasteurizer. By means of the measurement data and the received control data, the tunnel pasteurizer can be controlled in a programmed manner and enables remote-controlled optimization of pasteurization and maintenance processes.

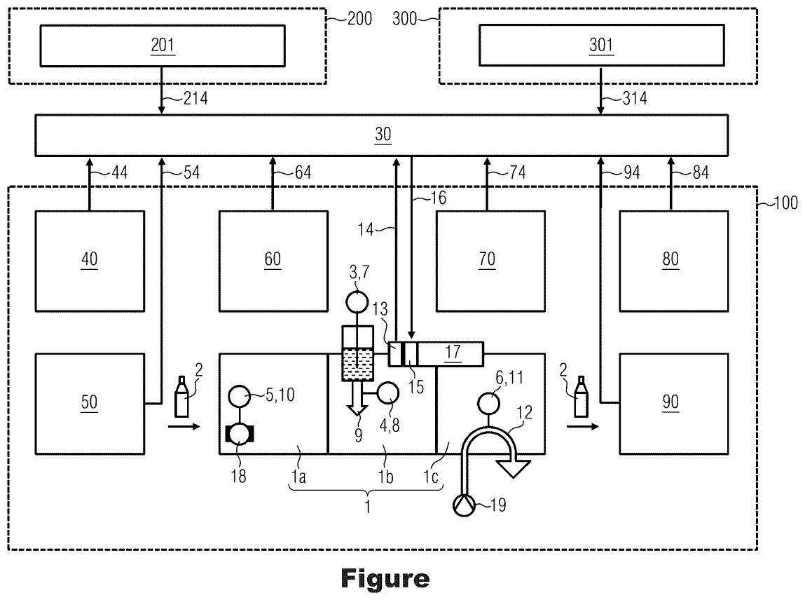

### CROSS REFERENCE TO RELATED APPLICATION

The present application claims priority to German Patent Application No. 10 2023 113 161.3 filed on May 19, 2023. The entire contents of the above-listed application are hereby incorporated by reference for all purposes.

### TECHNICAL FIELD

The disclosure relates to a tunnel pasteurizer for pasteurization of filled products, and to a method for monitoring and controlling such a tunnel pasteurizer.

### BACKGROUND

Tunnel pasteurizers are common components of plants for filling liquid products such as beverages into containers such as bottles. It is known in principle to continuously monitor by measurements machine parameters which relate, for example, to the transport or the temperature control of the containers in the tunnel pasteurizer. The same applies to parameters of consumables for tunnel pasteurizers such as biocides, cleaning agents, lubricants, or the like, whose fill levels, consumption and/or properties such as pH values or concentrations can be continuously monitored. Measurements of such machine parameters and consumable parameters then generally supply actual values which can be used, for example, by comparison with setpoint values for controlling or regulating the tunnel pasteurizer.

### SUMMARY

However, it is disadvantageous that the associated optimization and planning of operation requires a comparatively large amount of experience with the respective plant, and personnel with corresponding qualification.

There is therefore a need for improvement in this regard, for example in order to optimize tunnel pasteurizers more quickly after installation, maintenance, or production changeover and/or for more efficient provision of consumables.

The stated object is achieved with a tunnel pasteurizer and with a method for monitoring and controlling a tunnel pasteurizer, and with a filling plant comprising the tunnel pasteurizer, as described herein.

The tunnel pasteurizer is therefore used to pasteurize filling products. These are machine-filled containers, in particular bottles or cans, with flowable products, for example beverages.

In this regard, the tunnel pasteurizer includes: sensors for monitoring at least one consumable parameter, which is, for example, a local inflow, consumption or supply, or a property of a consumable of the tunnel pasteurizer, and for monitoring at least one machine parameter which relates to at least the transport
and/or the temperature control of the filling products, a data output for exporting measurement data obtained from the tunnel pasteurizer by means of such sensor monitoring; at least one data input for importing externally provided control data for controlling the tunnel pasteurizer; and a programmable logic controller for controlling the tunnel pasteurizer based on the received control data and measurement data that are obtained by means of sensor monitoring.

The obtained measurement data can therefore be collected and processed outside of the tunnel pasteurizer, for example in a cross-machine monitoring system. The external control data can also be generated there and transmitted to the tunnel pasteurizer.

Central processing of the measurement data and generation of the control data is therefore possible externally, for example to offset the measurement data obtained with the sensors against each other and/or against historical measurement data. This makes it possible, for example, to predict how certain configurations of machine and consumable parameters can affect future production processes. Historical measurement data or other empirical values of tunnel pasteurizers of comparable design can also be incorporated into the central/external data processing.

On this basis, the control data can be automatically generated and sent to the tunnel pasteurizer in order, for example, to adapt a specific machine state and/or an operating mode of the tunnel pasteurizer in a suitable manner. For example, an actuator of the tunnel pasteurizer can thereby be actuated directly, or an associated target value can be adjusted. This can relate to the monitored consumable and/or machine parameters.

By definition, monitoring is understood here to mean a continuous measurement repeated at sufficiently short time intervals so that a time profile of the monitored parameter within an ongoing production or maintenance process can be determined or predicted to plan such a process.

Consumables within the meaning of the present disclosure are in particular those for which batch-wise replenishment from transport containers or the like is required, for example biocides (disinfectants), cleaning agents, acids, and alkalis for pH regulation, technical additives such as corrosion protection agents, and lubricants for drives. Consumption from (public) supply networks can be considered in contrast to this. Within the meaning of the present disclosure, power, gas and fresh water consumption can therefore be regarded as machine parameters of the tunnel pasteurizer and can be correspondingly monitored.

Such central evaluation of the collected measurement data and generation of the control data takes place in a cross-machine monitoring system for digital location-independent monitoring of machine states (condition monitoring tool, also called a watchdog), which can for example be provided in a data cloud or on associated servers in a manner known in principle, independent of location. In this case, “cross-machine” can also be understood to mean, in particular, “cross-plant”, i.e., for example, comprising at least two production sites.

With such a cross-machine monitoring system, a display of measurement data, machine states and/or recommendations for action on mobile terminals is also possible, for example on a smartphone or a smart watch. Forecast data can also be determined and output in this way, for example a possible remaining runtime of the tunnel pasteurizer with stocks of consumables. Instructions for the replenishment of certain consumables can also be output in a mobile manner. Such information can, for example, also be sent directly to the tunnel pasteurizer in addition to the control data and displayed there.

In a filling plant comprising the tunnel pasteurizer, further measurement data and/or machine status data can also be determined and transmitted to the cross-machine monitoring system, for example from at least one measuring device for detecting an environmental condition in the region of the tunnel pasteurizer, from an inspection device connected upstream or downstream from the tunnel pasteurizer for inspecting the filling products to be pasteurized or that are pasteurized, and/or from at least one supply or disposal device connected to the tunnel pasteurizer for providing or disposing of a consumable of the tunnel pasteurizer.

Accordingly on the one hand, the operation of the tunnel pasteurizer can be adapted promptly to the measurement data and/or machine state data ascertained in this way. On the other hand, such measurement data and/or machine state data can also be stored by the cross-machine monitoring system for later data evaluations and used for statistical evaluations or the like, for example. The production mode of the tunnel pasteurizer can accordingly be optimized quickly and precisely both with regard to the current production mode in the filling plant and with regard to different empirical values with the tunnel pasteurizer or tunnel pasteurizers of the same design.

In the method for monitoring and controlling a tunnel pasteurizer, actual values of at least one consumable parameter which relates to a local inflow, consumption or stock and/or a property of a consumable of the tunnel pasteurizer, and actual values of at least one machine parameter which relates to the transport and/or the temperature control of the filling products, are monitored by sensors, in particular in the region of the tunnel pasteurizer in each case. Furthermore, measurement data obtained on this basis are sent into a region outside the tunnel pasteurizer and in particular outside the filling plant and, in return, control data correspondingly provided from outside are received for controlling the tunnel pasteurizer. Finally, the tunnel pasteurizer is controlled on the basis of the received control data and measurement data obtained by means of the sensor monitoring in an electronically programmed manner.

### BRIEF DESCRIPTION OF THE FIGURE

An embodiment of the disclosure is illustrated in the drawing. The single FIGURE schematically shows a tunnel pasteurizer as a component of a filling plant and with a cross-machine monitoring system.

### DETAILED DESCRIPTION

As the FIGURE shows, the tunnel pasteurizer 1 is part of a filling system 100 and can, in a manner known in principle, comprise a plurality of temperature control zones 1a, 1b, 1c, through which the filling products 2, for example bottles or cans filled with beverage, pass while standing on conveyor belts (not shown) for the pasteurization thereof.

The tunnel pasteurizer 1 comprises sensors 3, 4, 5, 6 for the ongoing monitoring of at least one consumable parameter 7, 8 of at least one consumable 9 of the tunnel pasteurizer 1 and for monitoring at least one machine parameter 10, 11 of the tunnel pasteurizer 1 relating to the transport and/or the temperature control of the filling products 2.

In the shown example, a first sensor 3 measures a first consumable parameter 7, which here is a fill level of a consumable 9, for example a biocide for disinfecting the tunnel pasteurizer 1, whose supply here is only shown symbolized. Furthermore, a second sensor 4 measures a second consumable parameter 8 which here relates, by way of example, to a property of the consumable 9, for example its concentration, temperature or pH value.

A plurality of consumable parameters 7, 8 of the tunnel pasteurizer 1 may be monitored (independently of the shown embodiment), for example an inflow, consumption, supply and/or a property of the respective consumable 9.

Monitored consumables 9 are (irrespective of the shown embodiment) in particular those that are used for production mode and regular maintenance of the tunnel pasteurizer 1 and are to be replenished as required, for example for hygienic and reliable pasteurization of the filling products 2, for cleaning and/or separate disinfection of the tunnel pasteurizer 1 and/or as auxiliary materials for its units or actuators, for example for belt lubrication or the like.

As examples of machine parameters within the meaning of the present disclosure, a first machine parameter 10 in the form of a transport speed of the filling products 2 in the tunnel pasteurizer 1 is measured with a third sensor 5, and a second machine parameter 11 in the form of a temperature of temperature control water 12 for controlling the temperature of the filling products 2 in the tunnel pasteurizer 1 is measured with a fourth sensor 6. Other conceivable machine parameters 11 would, for example, be the conductance, the pH or a microbiological characteristic quantity for the temperature control water 12 or similar process media.

At least one consumable 9, for example a biocide and/or another technical additive, can be added automatically to the temperature control water 12 circulating therein in the production mode of the tunnel pasteurizer 1, for example by means of metering devices (not shown) known in principle. Likewise, a corresponding metered addition to a cleaning liquid and/or to flushing water (not shown) is possible for maintenance.

The tunnel pasteurizer 1 comprises at least one data output 13 for transmitting measurement data 14 which are obtained by at least one of the sensors 3 to 6. The measurement data 14 can be both raw data and measurement data processed in a suitable manner in the region of the tunnel pasteurizer 1.

The transmission of the measurement data 14 is to be understood as meaning the export thereof to a region outside of the tunnel pasteurizer 1 and in particular to a region outside the filling plant 100 comprising the tunnel pasteurizer 1.

The tunnel pasteurizer 1 comprises at least one data input 15 for receiving external control data 16, that is to say, such that are generated outside the tunnel pasteurizer 1 and in particular outside the filling plant 100 comprising said tunnel pasteurizer, for controlling the tunnel pasteurizer 1, and are imported from there.

During production mode, the measurement data 14 may be exported continuously, and the receipt of the external control data 16 is then continuously possible.

The tunnel pasteurizer 1 comprises at least one programmable logic controller 17 for controlling the tunnel pasteurizer 1 by means of the control data 16 received via the at least one data input 15 and by means of at least a portion of the measurement data 14 which are obtained by means of the sensors 3 to 6. These measurement data 14 can be processed internally by the controller 17 and/or already suitably processed and transferred thereto.

The control data 16 can, for example, be target values of individual consumable parameters 7, 8 and/or individual machine parameters 10, 11, which can be compared to the actual values determined by the sensors 3 to 6 in a manner known in principle to control the tunnel pasteurizer 1. However, the control data 16 can also be control signals for directly controlling actuators of the tunnel pasteurizer 1. For example, the control data 16 can be used to control a belt drive 18 for transporting the filling products 2 through the tunnel pasteurizer 1 and/or at least one pump 19 for conveying the temperature control water 12.

The described control functions (or regulation functions) are to be understood as examples of the aforementioned control of the tunnel pasteurizer 1 and are based on corresponding programming of the controller 17, which in principle have a known architecture and can comprise input and output functions for operators.

The measurement data 14 are exported and the control data 16 are imported here between the tunnel pasteurizer 1 and a cross-machine monitoring system 30, which can also be referred to as a condition monitoring tool or so-called watchdog.

The cross-machine monitoring system 30 may operate on the basis of a data cloud and can therefore be provided, for example, on external servers.

The export and/or import of the measurement data 14 or of the control data 16 is possible, for example, wirelessly from/to the tunnel pasteurizer 1. It would also be conceivable to equip individual temperature control zones 1a to 1c with their own data outputs 13 and data inputs 15 of the described type in the sense of a modular design of the tunnel pasteurizer 1 (not shown).

The measurement data 14 sent by the tunnel pasteurizer 1 can be stored and evaluated in the cross-machine monitoring system 30. On the one hand, these can be assigned to the tunnel pasteurizer 1 overall and, on the other hand, to individual pasteurization processes (production batches) of the tunnel pasteurizer 1. This enables statistical evaluations of the measurement data 14 even over a plurality of pasteurization processes in the sense of historical process/plant optimization.

The cross-machine monitoring system 30 can also process measurement data of other process units of the filling plant 100 and compare and/or calculate them with measurement data 14 of the tunnel pasteurizer 1.

For example, the filling plant 100 can comprise: a bottle washing machine 40 for empty bottles; a filling machine 50 for filling the filling products 2; a disposal unit 60 for waste water disposal and optionally conditioning the temperature control water 12; a supply unit 70 for providing a consumable 9 such as, for example, chlorine dioxide; a cooling tower 80 associated with the tunnel pasteurizer 1; and/or an inspection unit 90 for the pasteurized filling products 2.

Such process units can in each case optionally transmit associated measurement data 44, 54, 64, 74, 84, 94 by corresponding data export to the cross-machine monitoring system 30, wherein this can be consumable and/or machine parameters of the respective process unit.

A cross-machine evaluation of measurement data 14, 44, 54, 64, 74, 84, 94 in the monitoring system 30 is therefore possible, and therefore a correspondingly comprehensive creation and transmission of external control data 16 to the tunnel pasteurizer 1 is possible.

The cross-machine monitoring system 30 can also work across plants, for example, including measurement data 214, 314 which are transmitted by at least one tunnel pasteurizer 201, 301 of at least one further filling plant 200, 300. Likewise, measurement data of other process units (not shown) of the corresponding filling plant 200, 300 could be transmitted to the cross-machine monitoring system 30.

By a cross-plant evaluation of measurement data 14, 214, 314 of tunnel pasteurizers 1, 201, 301, which can be structurally identical with regard to certain specifications, a plurality of measurement data of the described type can be offset with one another and used as the basis for the output of external control data 16 for the tunnel pasteurizer 1. Numerous empirical values can therefore be used both for cross-machine process and plant optimization within the filling plant 100 and across plants, i.e., taking into account a plurality of filling plants 100, 200, 300.

With the aid of the described export of measurement data 14 and import of external control data 16, machine functions, the supply of consumables, and/or the maintenance of the tunnel pasteurizer 1 can be automatically controlled remotely, for example by the cross-machine monitoring system 30, i.e., by a digital route or by online management.

The sensors 3 to 6 can monitor both consumable parameters 7, 8, such as for example concentrations and/or fill levels of consumables 9, such as for example additives for the temperature control water 12 or the like, also machine parameters 10, 11 which can be, for example, a water temperature, a water quality, a water consumption, an energy consumption, a pump pressure, a filter permeability, or the like.

Likewise, ambient conditions or environmental parameters, for example the outside air temperature and/or the outside air humidity in the region of the tunnel pasteurizer 1, and/or microbiological parameters, for example of the temperature control water 12, can be measured and can be incorporated as measurement data 14 into the external data evaluation and generation of control data 16.

The detection of the measurement data 14 and the transmission of the control data 16 is therefore possible fully automatically together with the associated control of the tunnel pasteurizer 1. For example, control signals for individual actuators of the tunnel pasteurizer 1 can be transmitted directly thereto, and/or operating modes or control programs of the tunnel pasteurizer 1 can be automatically selected by means of the control data 16.

Measurement data 94 obtained during product inspection, particularly on the output side, can also be incorporated into the processing of the measurement data 14 and the generation of the control data 16. For this purpose, for example, the quality of pasteurization and the integrity of the filling products 2 can be continuously monitored during production mode. Given inadequate control results, the tunnel pasteurizer 1 can automatically react to the corresponding quality deviations by means of the external control data 16.

The cross-machine monitoring system 30 can use self-learning algorithms in order to successively optimize the treatment quality and/or efficiency of the production or maintenance on the basis of an increasing wealth of experience of measurement data 14.

On the basis of the received measurement data 14, the cross-machine monitoring system 30 can automatically react to specific machine states or fault states of the tunnel pasteurizer 1 or to evaluations of the measurement data 14 and, for example, carry out a remote diagnosis and/or initiate troubleshooting remotely.

In addition, measurement data 14 from the tunnel pasteurizer 1 can be directly processed in a manner known in principle, for example in the controller 17, in order to generate internal control data (not shown).

With the tunnel pasteurizer 1 and the described method for the monitoring and control thereof, process conditions of pasteurization can be successively improved by an additional evaluation of historical measurement data 14 (earlier pasteurization processes/production batches). In addition, consumable 9 can be used more efficiently, and their replenishment can be automatically organized automatically and as required.

The collected measured data 14 can in principle be used across sites for comprehensive external data analysis and optimization of pasteurization processes.

In the described tunnel pasteurizer 1 or with the described method, machine parameters 10, 11, for example relating to the function of drive chains, conveyor belts, the formation of deposits in pipes/lines, the operability of valves, the temperature control of individual temperature control zones 1a, 1b, 1c, the metering of biocides for disinfection, the function of pumps, the functionality of metering and measuring devices, and the like, can be centrally monitored and, if necessary, optimized automatically. Possible error sources and personnel required for these purposes can thereby be considerably reduced.

The use of consumables 9 can be correspondingly optimized, for example of oxidizing biocides (such as chlorine dioxide or chlorine bleach liquor) or organobibiocides/non-oxidizing biocides (such as isothiazolinones) for disinfection of the tunnel pasteurizer 1 or the temperature control water 12, the use of cleaning agents, technical additives such as brightening agents or agents for corrosion protection, for suppressing scale formation or for stabilizing hardness, and/or acids and alkalis for pH regulation. Likewise, the consumption of lubricants, for example for transport belt lubrication, within the tunnel pasteurizer 1 can be minimized.

By means of the described sensors 3 to 6, for example, the fill level, consumption and/or a property such as the concentration of certain consumables 9, for example of biocides for disinfection, can be monitored. Likewise, for example, a water quality, such as pH, visual cleanliness, turbidity, microbiological load or the like of process media, such as the utilized temperature control water 12, can be continuously monitored. Tests of the material compatibility are also possible, for example the corrosiveness of certain consumables 9 in lines and on the inner walls of the tunnel pasteurizer 1.

On the basis of the measurement data 14, maintenance processes can be automatically requested or initiated, for example boiling out the tunnel pasteurizer 1, wherein the caustic solution used for this would then be regarded as a consumable 9, or replacing the temperature control water 12.

The type, number, and arrangement of the described sensors 3 to 6 and the actuators controlled by means of the control data 16, such as for example the belt drive 18 and the pump 19, are merely exemplary and representative of other sensors, actuators, and assemblies of tunnel pasteurizers 1 known in principle. This also applies to the aforementioned consumable parameters 7, 8 and machine parameters 10, 11.

1. A tunnel pasteurizer for the pasteurization of filling products, comprising:
sensors for monitoring at least one consumable parameter in the form of a local inflow, consumption, supply, and/or a property of a consumable of the tunnel pasteurizer, and for monitoring at least one machine parameter relating to the transport and/or the temperature control of the filling products in the region of the tunnel pasteurizer,
a data output for transmitting measurement data obtained from the tunnel pasteurizer by means of such sensor monitoring,
at least one data input for receiving external control data for controlling the tunnel pasteurizer; and
a programmable logic controller for controlling the tunnel pasteurizer on the basis of the received control data and measurement data obtained by means of sensor monitoring.

2. The tunnel pasteurizer according to claim 1, wherein the sensors are designed to measure actual values of at least two of the following consumable parameters or machine parameters: fill level, consumption or concentration of a biocide, fill level, consumption or concentration of an agent for scale prevention and/or hardness stabilization; fill level, consumption or concentration of a brightener; fill level, consumption or concentration of an anti-corrosion agent; pH value of an alkali or acid; fill level or consumption of a lubricant; conductance, turbidity or microbial load of temperature control water; water temperature in temperature control zones of the tunnel pasteurizer; drive speed of a conveyor belt drive; valve position on, flow rate through, or coating thickness in a line for the consumable or temperature control water; performance of a pump for a consumable or temperature control water; performance of a dosing device for a consumable.

3. The tunnel pasteurizer according to claim 1, wherein the controller is programmed to automatically adjust a machine state and/or operating mode of the tunnel pasteurizer on the basis of the received control data.

4. The tunnel pasteurizer according to claim 1, wherein the data input for reception of the control data is formed by a cross-machine monitoring system, and the data output is designed to transmit the measurement data thereto.

5. A filling plant comprising the tunnel pasteurizer according to claim 4 and at least one of the following process units set up in each case for transmitting measurement data and/or machine state data to the cross-machine monitoring system: a measuring device for detecting an environmental condition; an inspection device connected upstream or downstream from the tunnel pasteurizer for inspecting the filling products to be pasteurized or that are pasteurized; a supply unit connected to the tunnel pasteurizer for providing a consumable of the tunnel pasteurizer; and a disposal unit connected to the tunnel pasteurizer for disposing of and treating temperature control water.

6. A method for monitoring and controlling a tunnel pasteurizer for filling products, wherein: actual values of at least one consumable parameter relating to an inflow, consumption, stock and/or a property of a consumable of the tunnel pasteurizer and actual values of at least one machine parameter relating to the transport there and/or the temperature control of the filling products are monitored by sensors; measurement data obtained on this basis are transmitted to a region outside the tunnel pasteurizer; control data provided outside the tunnel pasteurizer are provided for controlling the tunnel pasteurizer; and the tunnel pasteurizer is controlled in an electronically programmed manner on the basis of the received control data and measurement data obtained by means of the sensor monitoring.

7. The method according to claim 6, wherein the consumable parameters or machine parameters comprise: fill level, consumption or concentration of a biocide, fill level, consumption or concentration of an agent for scale prevention and/or hardness stabilization; fill level, consumption or concentration of a brightener; fill level, consumption or concentration of an anti-corrosion agent; pH value of an alkali or acid; fill level or consumption of a lubricant; conductance, turbidity or microbial load of temperature control water; water temperature in temperature control zones of the tunnel pasteurizer; drive speed of a conveyor belt drive; valve position on, flow rate through, or coating thickness in a line for a consumable or temperature control water; performance of a pump for a consumable or temperature control water; performance of a dosing device for a consumable.

8. The method according to claim 6, wherein a machine state and/or operating mode of the tunnel pasteurizer are automatically adjusted by means of the received control data.

9. The method according to claim 6, wherein the measurement data are sent to a cloud-based cross-machine monitoring system, and the control data are received thereby.

10. The method according to claim 9, wherein the control data are calculated from the cross-machine monitoring system on the basis of the transmitted measurement data of an ongoing production process in the tunnel pasteurizer and corresponding measurement data of at least one historical production process in the same and/or in a substantially identical tunnel pasteurizer.

11. The method according to claim 10, wherein the control data are calculated by the cross-machine monitoring system on the basis of the transmitted measurement data and at least one environmental condition measured in the region of the tunnel pasteurizer, and/or at least one inspection result measured on the filling products to be pasteurized or that are pasteurized in the tunnel pasteurizer, and/or at least one measurement result and/or machine state of a supply unit connected to the tunnel pasteurizer for the provision of a consumable, and/or at least one measurement result and/or machine state of a disposal unit connected to the tunnel pasteurizer for the disposal and treatment of temperature control water.

12. The method according to claim 10, wherein the cross-machine monitoring system is further configured to output instructions for the replenishment of at least one monitored consumable from the transmitted measurement data.

13. The method according to claim 7, wherein the consumable is metered into the temperature control water circulating through the tunnel pasteurizer.

14. The tunnel pasteurizer of claim 3, wherein the controller is programmed to automatically adjust the machine state and operating mode of the tunnel pasteurizer including the monitored consumable parameters and/or machine parameters.
